(19) United States
(12) Patent Application Publication
(10) Pub. No.: US 2005/0036034 A1
(43) Pub. Date: Feb. 17, 2005

(54) Apparatus for communicating over a network images captured by a digital camera

(76) Inventors: David D. Rea, Rochester, NY (US); Douglas F. Rea, Mendon, NY (US); Arthur F. Shufelt, Honeoye Falls, NY (US); Donald B. Kent, Webster, NY (US); Jonathan E. Gilmore, Rochester, NY (US)

Correspondence Address: Kenneth J. LuKacher, Esq.;South Winton Court, Suite 204, 3136 Winton Road South, Rochester, NY, 14623, US

(21) Appl. No.: 10/918,957

(22) Filed: Aug. 16, 2004

Related U.S. Application Data
(60) Provisional application No. 60/495,603, filed on Aug. 15, 2003.
(60) Provisional application No. 60/542,145, filed on Feb. 6, 2004.

(51) Int. Cl. H04N 5/225

(52) U.S. Cl. 348/207.1

(57) ABSTRACT

An apparatus is provided for communicating over a network images captured by a digital camera, such as a digital camera without an on-board network interface. The apparatus includes a housing separate from the digital camera having a processing unit with memory for storage of images, a camera interface card received in a memory card slot of the digital camera, and a cable or wireless connection coupling the camera interface card to the processing unit for data communication. The apparatus emulates a memory card to the digital camera, such that the digital camera's electronics operate with the memory of the processing unit through the camera interface card, as if such memory was on a memory card located in slot of the digital camera. Images captured by the digital camera are transferred, via the camera interface card and cable, to memory of the processing unit, and the digital camera can access images stored in memory of the processing unit. The processing unit has a wireless data network interface and Ethernet communication interface, whereby captured images stored in memory of the processing unit are queued in real-time for network transfer, and subsequently transferred via one of the network communication interfaces, to a computer system, such as an web site or file server, at a network destination address configurable in the processing unit. Data may be inputted by the user before and/or after image capture for association with images prior to their network transfer. The housing for the processing unit may be shaped like a motor drive unit and attached to the bottom of the camera, or worn by the user of the camera in the form of a belt pack or backpack.

This Application claims the benefit of priority to the U.S. Provisional Application Ser. Nos. 60/495,603, filed Aug. 15, 2003, and 60/542,145, filed Feb. 6, 2004, which are herein incorporated by reference.

### FIELD OF THE INVENTION

The present invention related to an apparatus (method and system) for communicating over a network images captured by a digital camera, and particularly to an apparatus for communicating over a network images captured by a digital camera without an on-board network interface using the memory card slot of the digital camera in which additional data can be associated with images captured prior to their transfer over the network. The invention is useful as an attachment or appliance to non-networked digital cameras (i.e., a digital camera without a network interface) for enabling such cameras to utilize data networks, such as the Internet, wireless networks, or LANs, without requiring modification of camera software or hardware. The apparatus may also be used by a digital camera already having an on-board network interface to provide an additional networking facility, which may utilize the data association feature of the present invention.

### BACKGROUND ON THE INVENTION

Digital photography has vastly streamlined and accelerated the state of the imaging industry. Photographic workflows have been made possible through digital photography whose efficiency and speed could never have been achieved using conventional silver-halide photographic processes. Still, one bottleneck remains: photographic recording media, whether it is silver-halide film or digital storage cards, must be delivered by hand after recording. This causes delay and contributes highly to missed shots on the part of photographers in both film-based and digital photographic workflows.

Digital photography has the unique opportunity to eliminate these problems. Through the use of data networks, digital images can be transmitted to the beginning stages of the photographic workflow almost instantaneously following their capture. However, most digital cameras are non-networked in that they lack means for enabling network access to their images stored on their recording media. Such cameras store their images on removable CompactFlash memory cards typically interfaced via a slot of the camera. To transfer images to another computer system, the memory card is removed from the camera and inserted in a compatible port or slot of a computer system, such as a personal computer or smart printer. Also, digital cameras may transfer images stored on their memory card to a computer system over a cable via protocols, such as USB or IEEE-1394. The user of the computer system where such transferred image files are stored may then send such files manually over a network, such as via an Internet or LAN connection.

In contrast to such non-networked digital cameras, networked (or network enabled) digital cameras have a built in on-board network interface with connectivity software. Examples of networked digital cameras are shown in U.S. patent application Publication Nos. 2002/0167595 or 2001/0010543, and U.S. Pat. Nos. 6,167,469 and 6,353,848. Often such digital cameras can communicate their images to an image server, see also U.S. Pat. No. 6,337,712. Mobile phones may also represent a networked digital camera when they include a tiny digital camera for wireless transfer of generally low resolution and low quality images. Another networked digital camera is the Ricoh RDC-i700 which allows images to be transmitted via a limited selection of mobile data network and wireless LAN cards that fit into the camera's PCMCIA interface slot. Recently, Nikon has introduced the Nikon D2H digital camera having an optional WT-1 wireless transmitter attached to the bottom of the camera and connected via a USB 2.0 interface on the digital camera. Software in the Nikon D2H digital camera enables wireless transfer of images using FTP.

Despite the availability of networked digital cameras, most digital cameras on the market and in common use are non-networked cameras as they lack the necessary network interface and linking software for network access. Thus, it would be desirable to enable network accessibility of images captured by non-networked digital cameras to enhance their versatility that does not require any modification of their software or hardware. Moreover, it would further be desirable if such image captured by such non-networked digital cameras can be transmitted via data networks in real-time after image capture. Such an apparatus would be especially useful for professional digital photography, such as by media photographers or commercial portrait photographers.

Apparatuses for transmitting images from a digital camera over a network have been developed. For example, U.S. Pat. No. 6,301,607 describes an Internet access appliance coupled to a digital camera for downloading images over the Internet. U.S. Pat. No. 5,754,227 describes a digital camera having an external input/output (I/O) interface card through which the camera is monitored and controlled. The I/O interface card can operate as a modem to transfer images from the camera over a cellular, wireless, or land based phone.

Other apparatuses have been proposed to transfer images by emulation of a conventional memory Flash card for a camera. For example, U.S. patent application Ser. No. 2003/074179, published Apr. 17, 2003, describes a data transfer interface flash card for emulating a conventional flash card for a digital camera, where the card has memory for storing images prior to their transfer. International PCT Publication No. WO/01/58138, published Aug. 9, 2001, describes a transceiver unit which may be integrated with, or separate from, a digital camera for transferring images from the digital camera and then wirelessly transmitting the images over a computer network. The transceiver unit may be connected to the camera by a memory unit emulator for transferring images from the digital camera to the transceiver unit. The memory unit emulator has additional processing capabilities for responding to command sets.

It is often important to allow a user to add information about the images taken by the digital camera prior to transfer of the images, especially for professional digital photography by commercial portrait photographers, media photographers, and photography by cruise lines or theme parks. Such additional information may describe the image subject, background, location, or other descriptive information useful for later identification, selection, or sorting of transferred images. Without such information for association with images, each image captured has to be reviewed, which can be time consuming when large numbers of images are transferred. Moreover, review of such images transferred over the network by others can be difficult and inaccurate since they where not present when the images where taken. Although emulation of a memory card is useful for adding to a digital camera the capability of network transfer of image files by the transceiver unit of International PCT Publication No. WO/01/58138 or a data transfer interface flash card of U.S. patent application Ser. No. 2003/074179, the captured image files stored in the transceiver unit or a data transfer interface flash card are not modified with such additional desired information about images, e.g., by modifying image filenames, without negatively effecting their emulation of a memory card to the digital camera, since if their stored image files were modified, the files would no longer be accessible by the digital camera which took the images. Such accessibility is necessary for enabling typical digital camera operations such as preview on a camera's display, erasure (deletion) of image files, or any other operation requiring image memory access. Further, adverse or fatal software conditions may occur in the digital cameras operating software if previously stored images are not accessible. Accordingly, full emulation of a memory card for a digital camera with data association in captured files is not possible in International PCT Publication No. WO/01/58138 or U.S. patent application Ser. No. 2003/074179.

### SUMMARY OF THE INVENTION

Accordingly, it is an object of the present invention to provide an improved apparatus for communicating over a network images captured by a digital camera using the memory card slot of the camera.

It is another object of the present invention to provide an improved apparatus for communicating over a network images which provides full emulation of a memory card to the digital camera with the ability to associate additional data in the image file prior to their transfer over a network that may be useful for both networked and non-networked type digital cameras.

Briefly described, the present invention embodies an apparatus including a housing separate from the digital camera having a processing unit with memory for storage of images, a camera interface card received in a memory card slot of the digital camera, and a cable or wireless connection coupling the camera interface card to the processing unit for data communication. The apparatus emulates a memory card to the digital camera, such that the digital camera's electronics operate with the memory of the processing unit through the camera interface card, as if such memory was on a memory card located in the digital camera. As a result, file operations by the digital camera on its image files stored in memory of the processing unit appear to the electronics of the digital camera as if such image files were stored on a memory card in the camera. Images captured by the digital camera are transferred, via the camera interface card, to memory of the processing unit, and the digital camera can access (e.g., read) images stored in memory of the processing unit. The processing unit has a wireless data network interface and Ethernet communication interface. In the processing unit, captured images stored in its memory are queued in real-time for network transfer, and subsequently transferred via one, of the communication interfaces, via a network, to a network destination address associated with a computer system, such as an web site or file server, as network connectivity and bandwidth permit. Images are transferred using a network and communication protocol configurable in the processing unit. No modification is required at the digital camera, as the camera operates at if it is writing or reading image files to a conventional memory card.

The memory of the processing unit may be partitioned to provide a first partition for storage of originally captured images, and a second partition for storage of copies of the captured images with modified file names and/or headers with data images inputted to the processing unit by the user for association with such before image capture and storage, or after image capture and storage in the processing unit. If data association is enabled, a modified image file is transferred over the network from the second partition, and if data association is not enabled, the original image file is transferred over the network from the first partition. The first partition for storage of originally captured images in the processing unit may further be partitioned to provide plurality of virtual CompactFlash cards.

A method is also provided for communicating over a network images captured by a digital camera using a memory card slot of the camera having the steps of: providing a computer system having memory for storage of images; inserting a camera interface card in the memory card slot of the camera; coupling the camera interface card to the computer system for data communication; and emulating operation of a memory card for transfer of images captured by the camera for storage in memory of the computer system, in which the camera has access to the stored images in the memory of said processing unit. Also, the method may provide associating user data inputted (e.g., via configuration data set by the user in the processing unit and/or a reader coupled to the processing unit) with images prior to communicating the images over the network The housing may be shaped like a motor drive unit and attached to the bottom of the camera, or worn by the user of the camera in the form of a belt pack or backpack.

The apparatus of the present invention may also be referred to as an attachment or appliance attachable to a digital camera's memory card interface for enabling network connectivity and communication, with or without data association.

### BRIEF DESCRIPTION OF THE DRAWINGS

The foregoing objects, features and advantages of the invention will become more apparent from a reading of the following description in connection with the accompanying drawing, in which:

FIG. 1 is a block diagram of the apparatus according to the present invention;

FIG. 2 is a flow chart showing the operation of the apparatus of FIG. 1 for real-time storage of images captured by the camera, and subsequently transferring stored images over a network;

FIG. 2A is another flowchart showing the operation of the apparatus of FIG. 1 for real-time storage of images captured by the camera, data association with images, and subsequent transfer of images over a network;

FIG. 2B is a flowchart showing the operation of the data association block of FIG. 2A;

FIG. 3 is an example of the apparatus of FIG. 1 in which a belt pack houses the processing unit;

FIG. 4 is another example of the apparatus of FIG. 1 in which a backpack houses the processing unit;

FIG. 5 is a further example of the apparatus of FIG. 1 in which the processing unit is in a housing having the shape of a motor drive unit of a non-digital camera and is attachable to the base of the digital camera; and

FIG. 6 is a perspective view of an example of the housing of the processing unit of the FIG. 1.

FIG. 7 is a plan view of the processing unit of FIG. 6;

FIG. 8 is an top view of the processing unit of FIG. 6; and

FIG. 9 is a side view of the processing unit of FIG. 6.

### DETAILED DESCRIPTION OF INVENTION

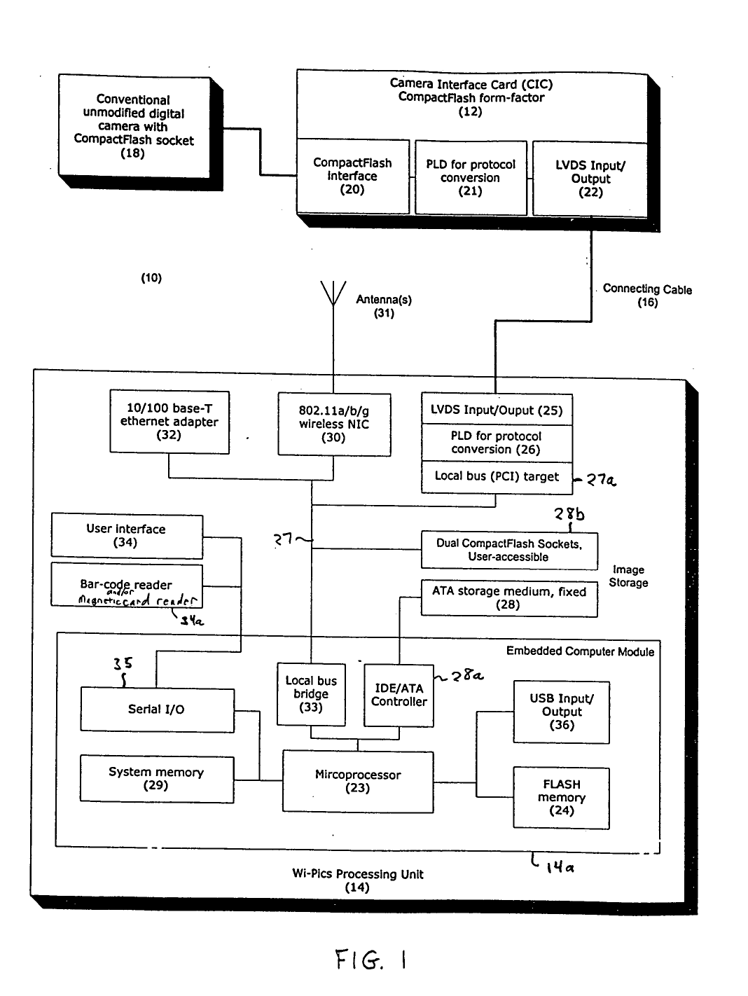

Referring to FIG. 1, the apparatus 10 has a camera interface card 12 and a processing unit 14 which are coupled by a cable 16. The camera interface card 12 has a CompactFlash compliant form factor and CompactFlash ATA edge connector (or interface) 20 of a typical CompactFlash memory card, such that the camera interface card 12 can be received in a CompactFlash interface slot of a typical digital camera 18 for communication with electronics of the camera. Camera interface card 12 has a transport connector or cable 22 connected to one end of cable 16, and the other end of the cable 16 is connected to a transport interface 25 of the processing unit 14. Other form factors may also be used for the camera interface card 12 depending on memory card interface of the particular digital camera to be used with the apparatus 10.

The camera interface card 12 receives ATA protocol commands and data from the camera 18, such a command is generally used by digital cameras in communicating with CompactFlash memory cards. Commands and data received are encoded (converted or translated) by camera interface card 12 for transmission over cable 16 to the processing unit 14. The camera interface card 12 also decodes encoded data received over cable 16 from the processing unit 14 for delivery to the electronics of the camera 18. A protocol conversion and transport circuit 21 in the camera interface card 12 provides such encoding and decoding of data between the ATA-protocol and the encoding transmission protocol used over cable 16. For example, such encoding and decoding by the protocol conversion and transport circuit 21 is provided by a programmable logic device (PLD), preferably a Field Programmable Gate Array (FPGA) or ASIC to encode commands. The electrical connections provided by cable 16 between the transport interface 25 and the protocol conversion and transport circuit 21, via connector 22, is defined by the encoding transmission protocol. Preferably, the transmission protocol is Low Voltage Differential Signaling (LVDS), and the PLD of protocol conversion and transport circuit 21 converts (or encodes) CompactFlash signals (ATA commands and data) received from camera 18, via interface 20, into low voltage differential signals, which are transmitted by input/output interface 22 to the processing unit 14, via cable 16, and converts (or decodes) low voltage differential signals received from input/output interface 22 from the processing unit 14, via cable 16, into CompactFlash signals (ATA commands and data). A LVDS input/output interface may be National Semiconductor Chip DS92LV16, but other chips providing similar communication protocol may be used. Cable 16 is such that it is capable of enabling serial communicating via low voltage differential signals. Encoding and decoding methods for enabling other data transfer protocols may other be used, including wireless communication protocols (e.g., Bluetooth, or PSK (phase shift keying), FSK (frequency shift keying), ASK (amplitude shift keying), or other common serialized data protocols. As such, cable 16 may be replaced by two wireless, RF or IR, transceivers, one at the card 12 and the other at processing unit 14 to enable wireless communication of ATA commands and data in accordance with the wireless communication protocol. Cable 16 may also be replaced by an optical cable, e.g., optical fiber, wherein a common serialized optical protocol is used. For all of these communication protocols, detection and correction methods may be employed, such as parity bits, frame checking, or any other common error detection and correction methods.

The processing unit 14 represents a computer system having a microprocessor 23, which operates in accordance with a program stored in FLASH memory 24. FLASH memory 24 also stores the operating system software for the processing unit 14, such as Microsoft Windows CE, but other operating systems may be used. For example, microprocessor 23 may be an Intel xScale microprocessor (PCA family), but other microprocessors may be used. The microprocessor 23 may utilize system memory 29 (such as SDRAM) to run the operating system, as common to microprocessors. In the processing unit 14, the encoded data is received by a programmable logic device (PLD) 26, such as a Field Programmable Gate Array or FPGA, or ASIC from the input/output interface 25, which may the same as input/output interface 22 for receiving and transmitting low voltage differential signals over cable 16. The PLD 26 is programmed to decode encoded data received in accordance with the LVDS encoding protocol used by the PLD of protocol conversion and transport circuit 21, as described above, and to encode data for transmission to camera interface card 12. The PLD 26 may use other encoding and decoding methods for enabling other data transfer protocols, as described earlier. A separate chip or the PLD at each of card 12 and processing unit 14 performs error detection and correction described earlier. Also, the PLDs at each of card 12 and processing unit 14 may incorporate the data transport capabilities described earlier. Such encoding and decoding may represent a translation of commands, followed by accompanying data, if any, serially transmitted between the processing unit and the camera interface card 12. The PLD 26 places the decoded CompactFlash signals (i.e., ATA commands and data, if any) on a local bus 27 (such as a PCI-type bus) of the processing unit 14. CompactFlash signals (ATA commands and data, if any) from the camera 18 from card 12 are made available to the local bus 27 by a local bus (PCI) target circuit or chip 27a, via processing unit 14 electronics provided by components 25 and 26, and local bus (PCI) target circuit or chip 27a enables receiving of ATA commands and data, if any, over the local bus 27. Thus, the card 12 appears as a PCI peripheral on local bus 27. A Bus Controller 33, such as RISC-to-PCI Bridge IC or other typical local bus for the microprocessor 23, enables data communication by the microprocessor 23 to the local bus 27, and thus data communication with PLD 26. The microprocessor 23, FLASH memory 24, system memory 29, local bus bridge 33, IDE/ATA controller 28a, and a USB port 36 are located on a computer module 14a, such as an ARMCORE Module sold by Compulab Ltd. of Israel.

ATA driver software is provided in memory 24, such as part of the operating system, and used by the microprocessor 23 to retrieve the interpreted ATA commands and data, if any, from the PLD 26, and deliver them to an ATA storage device (or medium) 28. The ATA storage device 28 represents an actual ATA storage device. The ATA storage device 28 operates responsive to an IDE/ATA controller 28a which receives ATA commands from microprocessor 23. For example, ATA storage device 28 may represent a rotating-platter hard disk drive, such as an IBM/Hitachi Microdrive or hard disk drives such as used in laptop computer, or preferably, a non-volatile Flash Disk, such as a Fast Flash Disk sold by M-Systems, or a FLASH-based CompactFlash memory card, such as available from Lexar, SanDisk or Toshiba, that has a large capacity (e.g., 1-4 GB). Dual CompactFlash Sockets 28b may also be provided in processing unit 14 which may be optionally utilized by a user, such as when the ATA storage device (e.g., hard drive) 28 is full or when no ATA storage device is present in the processing unit. For example, such ATA commands include read, write, or erase. Further, the ATA protocol supports inquiries sent between the digital camera and the ATA storage device 26 to determine when the storage device is ready to read an image file, write an image file, or perform other memory function in accordance with the digital camera. ATA protocol is a known standard for data communication. Reference to the ATA commands, storage, architecture, and communication between a CompactFlash and an ATA storage device, is described in CF+ and CompactFlash Specification Revision 2.0, CompactFlash Association, Palo Alto, Calif., 1998-2003, and Information Technology—AT Attachment with Packet Interface—6 (ATA/ATAPI-6), T13/1410D revision 3a, published by ANSI NCITS 2001. Transfer of image data by the ATA driver, such as provided in a read or write command, may be by direct memory access (DMA), or other commonly used data transfer techniques. The type of files stored on the ATA storage device 28 depends on the digital camera which reads and writes to the device 28. In this manner, digital camera 18 communicates with apparatus 10 identical to that of a typical CompactFlash memory card, such as for storage (writing) of images captured by the digital camera in files on ATA storage device 28, reading of such images from the ATA storage device for preview on a display of the digital camera, erasure (deletion) of image files, or any other memory access operations supported by the digital camera 18 with respect to a CompactFlash memory card if installed in the digital camera. Thus, the apparatus 10 emulates a CompactFlash memory card to the digital camera.

Image files once stored on the ATA storage device 28 are made available by the operation system and the ATA driver for transfer by the processing unit 14 over a network, such as an Internet, wireless network or LAN, to another computer system, such as a website, LAN server, or other image server, or any other electronic computer-based device having a network or IP address configured to receive image data from the network, such as a smart printer, PDA, wireless computer, or the like. Configuration data stored in memory 24 is read by the microprocessor 23 to determine the destination network address or path for transfer of stored captured images upon their detection by the processing unit (real-time transfer), or when the network becomes available to the processing unit for such transfer to take place (queued transfer). Each image detected is queued in real-time for network transfer in a queue file or list in memory 24. As multiple images can be stored by the digital camera in storage device 28 faster than images can be transferred over a network, only the first stored image may be real-time transferred from the queue, the rest are successively transferred as network connectivity and bandwidth permit. Thus, captured images can be sent over a network automatically without user intervention. For example, the destination network address may be a URL (website) address, LAN address, or identifier, or a data path to a LAN server or other computer system. For wireless transfer of images, such as WiFi (wireless LAN), a wireless (RF) interface 30 having an antenna 31 is provided in the processing unit 14. Wireless interface 30 may be a multimode 802.11 network interface (chip set) operating by 802.11 a, 802.11 b, 802.11 g, or other wireless protocols. To send images over a LAN (wire or cable), an Ethernet port 32 is provided on the processing unit 14. The Ethernet port 32 may be a 10/100 base-T Ethernet adapter, i.e., a 10/100 megabit-per-second wired Ethernet interface (chip set) 32 for transmission of images. Image file transfer may be in accordance with one of the transport protocols, such as SSH, FTP, UNC, NFS, HTTP, SMB, TCP/IP Client Server, or other transport protocol, as also defined by the configuration data. Optionally, USB port 36 may be used to enable the processing unit 14 to operate as a typical USB storage device for retrieval of image files from the ATA storage medium 28, without requiring access through network interfaces 30 or 32.

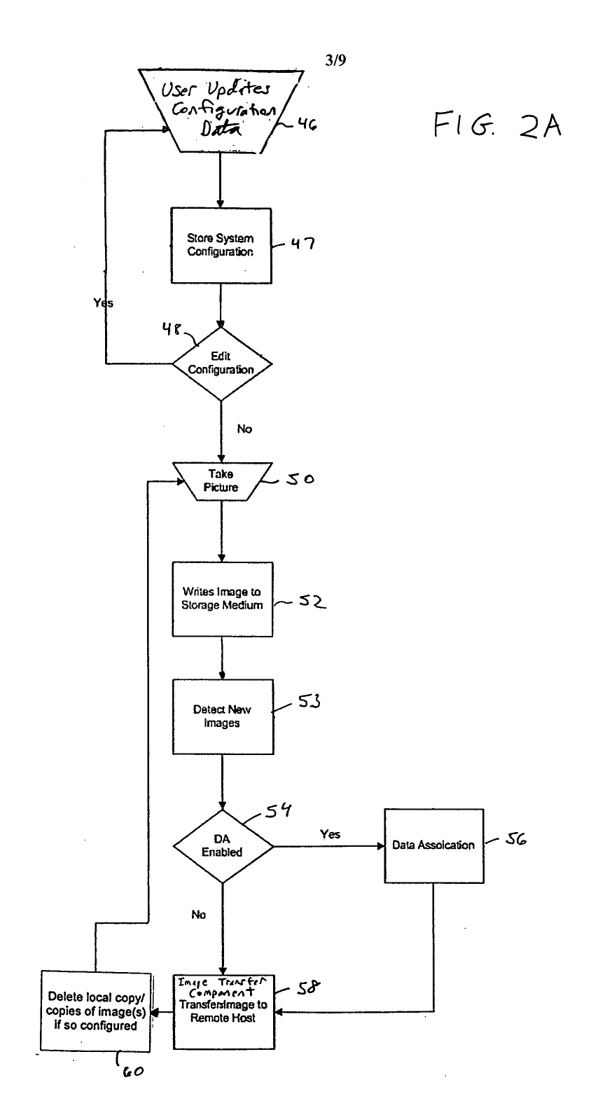

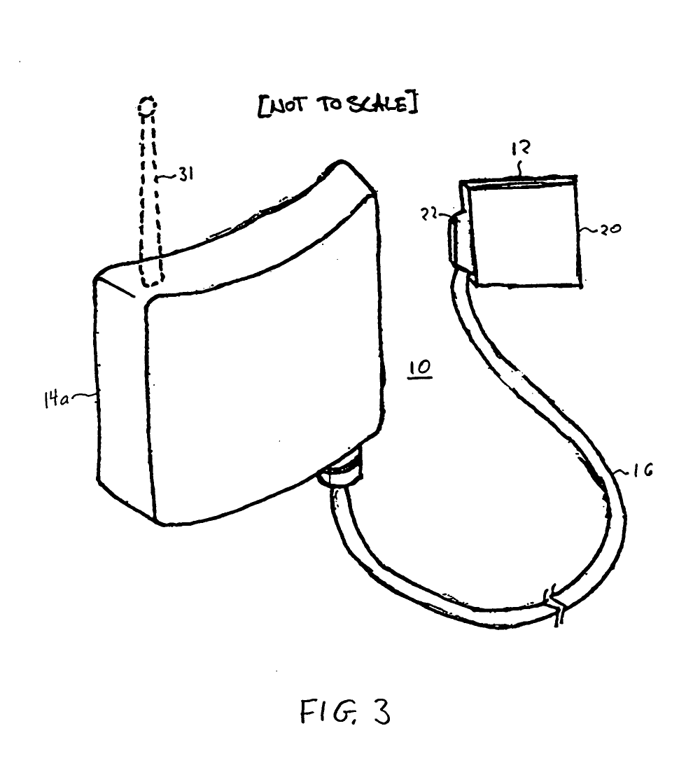

The processing unit 14 further has a user interface 34 coupled to the microprocessor 23. The user interface may represent on/off power or select (or toggle) or directional button(s) or keypad, and an LCD (or other type of display) on the processing unit's housing (14a, b, c in FIGS. 3-5). Information may be provided by the microprocessor on the display by use of such buttons or keypad, such as storage device capacity, battery power level, or status of the processing unit 14. Optionally, port(s) may be provided on the processing unit's housing to its microprocessor for coupling other devices, such as a computer system, PDA, PC, or laptop, for updating the configuration data in memory 24. The processing unit 14 may have a bar code and/or magnetic card reader 34a (or other type of scanner) or RFID reader coupled to the microprocessor 24. Data communication between the microprocessor 23 and the reader 34a and user interface 34, may be via a serial I/O interface 35 in the processing unit 14. The reader 34a may be integrated with the housing of processing unit 14 or represent a separate reader unit which can be coupled, such as by a cable to serial I/O interface 35. The reader 34a which may be attached to one of the microprocessor's serial ports to receive decoded barcode information, or decoding software may be provided in memory 24 for the microprocessor to decode barcode data (or other decoding for the particular image scanned or read). Optionally, a port or slot on the processing unit's housing to the microprocessor provides an interface with a card, chip, or other plug-in unit, which when inserted has memory storing configuration data for use by the microprocessor. Further, optionally a keyboard (and/or mouse or serial terminal) port may be provided along the processing unit's housing, where the processing unit is programmed like a typical computer for a user to interact via a graphic or textual user interface on a display (LCD or CRT-type), such as to update the configuration data in memory 24 or otherwise control processing unit operation.

The configuration data in memory 24 may be updated via a web server in memory 24 operating on the processing unit 14 to provide a web-based interface. A port is provided on housing of the processing unit 14 for enabling a user's computer system, such as a PC, laptop computer, PDA, or the like, to connect via a cable or wirelessly with the processing unit. Optionally, the user's computer system may be able to access the web server via one or both of the network interfaces 30 or 32, if available. This web server has an IP address available via user interface 34. A user at the user's computer system connected to the processing has browser software (e.g., Microsoft Explorer, NetScape Navigator, or the like) which via the IP address of the web server accesses web pages with data fields for enabling the user to input, modify, or verify configuration data. The user's computer system may have a graphical user interface (e.g., mouse, track pad, or other pointing device) for facilitating entry of data in the browser and web pages. Such update of configuration data can also be via user interface 34 on the processing unit 14 by toggling through the various input fields of a menu or submenus. Optionally, update of configuration data may occur via programming signals received via network interfaces 30 or 32, or a programming port on the processing unit's housing. When Windows CE is used as the operating system in processing unit 14, the configuration data updateable by the user (or via programming signals) may be organized in memory 24 in folders (or hives) and subfolders (subhives) in a registry, which is then available to the software programs (or components) of the processing unit 14. However, other data structures for storing configuration data may also be used. The updating of configuration data may occur with or without card 12 received in the digital camera.

Processing unit 14 handles all image storage, processing, transmission, and verification functions. Although not shown, other components are also provided in the processing unit, such as a battery (rechargeable) an AC adapter for supplying power to the processing unit, and power management circuitry, such as typical of portable electronic devices, such as PDAs, digital cameras, cell phones, laptop computers, or portable printers. The camera interface card 12 receives power from the processing unit 14 via cable 16. If no cable 16 is present, power may be provided by a battery coupled to the card, or power may be supplied from the camera, if available.

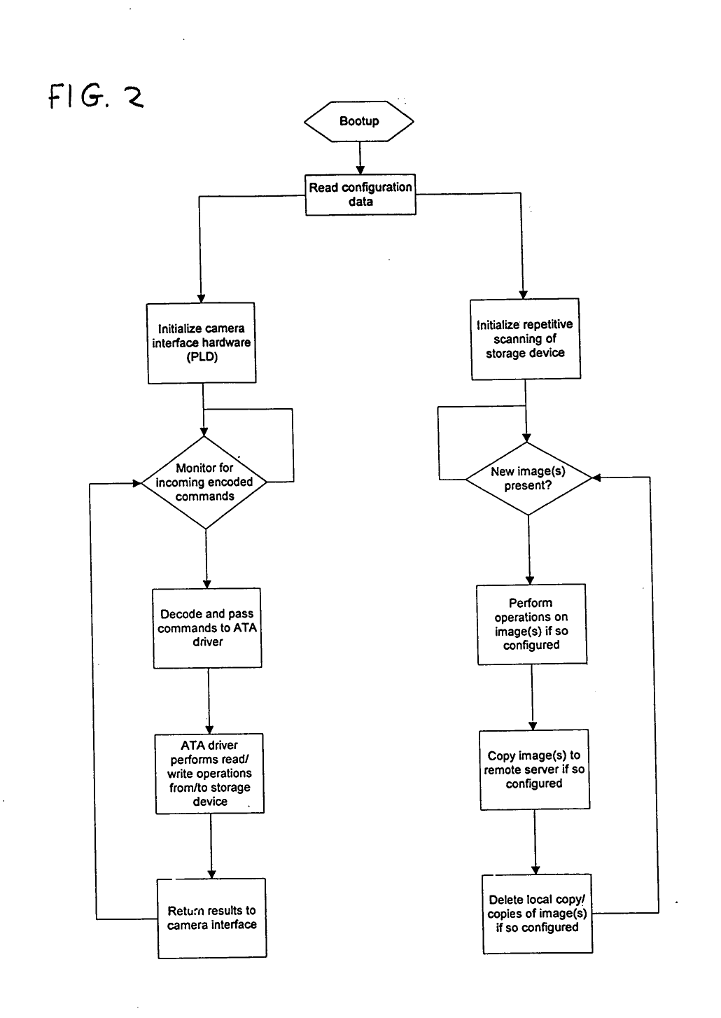

Configuration data includes network configuration settings over wired and wireless NICS 30 and 32, respectively, image transfer configuration over such configured network, and data association settings. For example, network configuration data in addition to the network destination address, may include network commutation protocol and authentication information. Image transfer configuration refers to settings for enabling image transfer, such as network communication protocol for sending files over a network, such as FTP, SSH, NFS, UNC, or other typical communication protocols, authentication information (e.g., ID, password, account number, or public key, if needed to access a remote server at the network destination address), and deletion protocols. Data association refers to settings for enabling of disabling data association, static data for association with all images captured, and enabling auxiliary mode for inputting auxiliary (or dynamic) data for association inputted via reader 34a which are changeable by the user either in pre-shot mode(i.e., before the next image(s) are captured by the camera), or i.e., post-shot mode (i.e., after image(s) are captured by the camera). Unlike prior art non-network digital cameras without system 10, such association was performed only after such image were manually downloaded from CompactFlash cards. Data association will be described in more detail below in connection with FIG. 2B.

Deletion protocols refer to whether image files should or should not be removed from memory of ATA storage device 28 once successfully transferred over a network, via interfaces 30 or 32. Further, such deletion protocols may include dummy image names if the particular digital camera receiving the apparatus 10 is sensitive to image removal by means other than by the camera. Other or different configuration data may also be provided, such as the camera model attached to the apparatus.

The memory of the ATA storage device 28 for storing image files is partitioned for data association having a first memory partition storing the original captured image files, and a second memory partition storing copies of original image files modified with associated data when data association (or tagging) is enabled. As stated earlier, data association is one of the configuration parameters which can be enabled by the user when the configuration data is entered or modified. The digital camera accesses the first memory partition to emulate accessibility of a memory card, and the second partition stores modified image files with the data association desired by the user. This enables full emulation by a digital camera to access captured images stored on the processing unit and data association with images, since if the original stored images once modified with such additional data (or tags), such as in image headers and file names, the image files will not be readable back (i.e., accessible) by the typical file operating system of a digital camera. The allows data to be associated with image files in the second partition prior to transfer over the network, while allowing the user to view, delete, or perform other typical memory operations on the original image files in the first partition stored in the processing unit. Thus, data association is provided with full emulation to mimic a memory card to a digital camera without modification of the camera software.

Optionally, the apparatus may be used with different digital camera models having different file structure requirements in memory of the ATA storage device 28. Thus, other partitions may be incorporated into the ATA storage device 28 in order to accommodate varying file system demands placed on the storage device by the digital camera, which maintains control of the file system, except for the second partition of the ATA storage device which may be considered controlled by the processing unit 14.

Management of the partition structure on the processing unit 14 internal ATA storage medium 28 is accomplished by the operating system and ATA driver software resident on the processing unit 14 and stored persistently in FLASH memory 24. Management refers to operations to create and remove partitions from the storage medium, operations to select the specific partition to which ATA commands should be issued, and operations to access the partitions for purposes of image transfer via the network interfaces 30 or 32.

The first partition for capturing original images may represent one or more first partition where the user creates additional partitions for storing captured images. Creation and removal of partitions in memory may be as typically performed in computer memory of personal computers. Selection of the specific partition to which ATA commands should be issued (hereafter the “partition of focus”) is effected by the user via the user interface 34 or web browser in the configuration data and enforced by the ATA driver. Subsequent access to the partitions (including but not limited to the partition of focus) for purposes of network transfer and configurable deletion or data association of/with images stored thereupon is provided by inter-operation between the operating system and the ATA driver; such inter-operation is due to the exclusive-accessibility nature of the ATA storage medium 28 and the subsequent necessary arbitration between ATA commands issued by the operating system and ATA commands issued by the ATA driver software. Further information regarding these properties of the ATA protocol and ATA commands is available in the AT Attachment with Packet Interface (ATA/ATAPI) specification cited earlier.

Further, individual partitions resident on the ATA storage medium 28 and managed by the operating system and ATA driver may be associated with human-readable names as effected by the user via the user interface 34 or web browser based configuration interface. Such associated names may be associated with the image files, recorded on the ATA storage medium 28 and transferred via one of the two network interfaces 30 or 32, via one or more of the means of association detailed earlier for barcode, magnetic strip, and/or statically defined data. Such associated names are stored in the same configuration data with previously configured data.

In typical non-network digital cameras, a user often used different CompactFlash card for different backdrops, photo shoots, subjects, etc . . . , such that images related to each other are stored in the same CompactFlash card. By creating different first partitions, virtual CompactFlash cards can be set up by the user where images related to each other are stored in the same partition. Optionally, when data association is enabled, different ones of the second partition may be created by the processing unit 19 which parallel those of the different ones of the first partition. The user, via the user interface or web page of the browser-based configuration interface, selects which partition to store images to be taken, rather than having to switch between CompactFlash cards. For example, a 10GB ATA storage medium 28 may have 10 partitions of 1GB each, or 5 partitions of 2GB each. If the camera being supported by the system 10 uses a FAT16 “file system”, then typically each partition would be 2.2GB, while a camera using a FAT32 “file system” can use all 10GB at one time. However, not all of the memory of medium 28 need be allocated for partitioning.

Referring to FIG. 2, the operation of the apparatus is shown after the camera interface card 12 has been inserted into the memory card slot of the digital camera 18. The right side of the flowchart describes the process for real-time transfer of captured images over a network, and the left side of the flowchart describes the process of transfer of captured images to the ATA storage device 28 of the processing unit 14. Both the right and left sides may occur in parallel in the processing unit, however priority is given to the left side process to minimize delay seen by the camera. First, the processing unit boots up by running the operating system and programming stored in memory 24. Such bootup may occur by activating of the processing unit (via the user interface) by the photographer or user of the digital camera, or when the camera interface card 12 is inserted into the memory card slot of camera 18, which activates the data transport mechanism between the card 12 and processing unit 14, e.g., an active link having handshaking. Next, the configuration data stored in memory 14 read by the microprocessor to determine which interface 30 and/or 32 to use, network settings, the network destination address, network transfer protocol to be used, static data association (or tags) to be added to image files when stored as modified files in the processing unit, deletion protocols, and other configuration data discussed earlier. The camera interface hardware, i.e., PLD 26, is then initialized to receive data from the camera interface card 12, and then monitors for incoming encoded commands over cable 16 or a wireless communication connection.

Upon receipt of an encoded command, the PLD decodes the command and passes it to the ATA software driver. The ATA software driver performs the read/wire operations from/to the ATA storage device 28, via IDE/ATA controller 28a. For example, the camera issues a command to read with data having at least an image file name, this command is encoded by the PLD 21 of the camera interface card into LVDS signals, the LVDS signals are decoded by the PLD 26, passed to the ATA software driver operating on microprocessor 23, which delivers it to IDE/ATA controller 28a. The IDE/ATA controller 28a in response returns image data blocks from the ATA storage medium 28 to the camera's electronics for that image file via the reverse data path. In another example, the camera issues a write command with data having the file name to be created, this command is encoded by the PLD 21 of the camera interface card into LVDS signals, the LVDS signals are decoded by the PLD 26, and passed to the ATA software driver, which delivers it to the IDE/ATA controller 28a for storage of the received image in a file in memory of ATA storage medium 28. As stated earlier, other signals than LVDS may be used for other communication protocols, such as wireless, RF or IR, were such interface is provided in the card 12 and processing unit 14, and PLD's 21 and 26 provide encoding and decoding for the communication protocol used.

The ATA software driver in addition to directing storage of the received image in a file in memory of ATA storage medium 28 in the first partition also adds the file name to its directory with any typical file information, such as size and date and time. Upon the camera detecting a ready state for the ATA storage device 28, the camera then sends successive image data blocks to the ATA storage device 28 by this data path, and before writing each block the camera's electronics waits for a ready state from the IDE/ATA controller 28a. In the ATA protocol, such ready state is determined by the camera electronics checking the status of one of the bits of an ATA configuration register of the ATA storage device or IDE/ATA controller 28a. After the write is complete, the IDE/ATA controller 28a sends an acknowledgement to camera. Before the camera electronics issues each command, it generally checks the status of the ATA register to assure that the ATA storage device is ready. Image data transfer may be carried out by DMA, as stated earlier, in the processing unit 14. The erase command is similar to a read command, in which the IDE/ATA controller 28a removes block(s) of data from the file directory in the ATA storage device 28, and returns an acknowledgement. The particular commands, data structures, returned data in communication with an ATA device are publicly available, and thus a detailed discussion has not been provided. For detailed information, reference is made to the AT Attachment with Packet Interface (ATA/ATAPI) specification cited earlier. If different first partitions in ATA storage device 28 have been created by the used, the ATA Driver will direct the image for storage in the partition previously selected by the user via user interface 34 or the web browser in the web-based interface.

Along the right side of FIG. 2, the processing unit initializes scanning of ATA storage device 28 to determine if a new image file is present. Such scanning may be carried out by comparing file names in the directory of the ATA storage device 28 with a list in memory, such as memory 29, of the directory of previous file names stored to determine if any new image file or files are present. (If deletion protocol requires removal of transferred images, then scanning would optionally entail detection of image files, without the need for comparison of file names). Upon detecting a new image file present in the directory of the ATA storage device 28, operations are performed on the image file, if such is set by the configuration data. As will be described in more detail in FIGS. 2A and 2B, when data association is enabled, such operations for example may be copying the image file into the second partition in the ATA storage device, and modifying the image data with header information and the file name in accordance with static data, modifying the header information with auxiliary data if auxiliary mode is enabled, prior to network transfer. Although preferably static data modifies both file name and image header, optionally only one of such may be modified. Also, copying of the image file may include conversion of file format if set by the user in the configuration data. The new image file detected is then transferred from the first partition if data association is not enabled, or the second partition if data association is enabled, over the network via a connection established by the processing unit, via the wireless network interface 30 or Ethernet interface 32, to the destination network address or path provided in the configuration data using the network communication protocol specified in the configuration data. However, if the new image file is one of a series of captured images, the image name, address, or the file, is queued in memory for transferring as network bandwidth permits. If authentication information is needed to access the remote computer system at the destination site associated with the destination network address or path, such as ID or password, account number, or the like, such is also specified in the configuration data and used when the image is transferred. Depending on the deletion protocol of the configuration data, the original image file stored in ATA storage device 28 is removed, and if needed, a dummy file (null or small file) is store in the storage device 28. The above steps may then be repeated for each new image file detected before the processing unit returns to scanning the storage device 28 for new image files. In this manner, images captured by the camera are immediately stored in ATA storage device 28 as if such were stored in a CompactFlash card in the camera, and are available for transfer over a network connection to other computer systems. Although a single destination network address is shown, multiple destination addresses having the same or different network communication protocol may be used, with any different authentication information, may be specified in the configuration data, such that image files are sent to multiple network sites or destination computers. If an image stored is detected by the processing unit, but the network connection is not available, the processing unit queues the image file names in its memory for transmission (single or batch) when it detects that the network connection has been established.

Thus, when an image is captured by the digital camera 18, the camera attempts to record the image file to a CompactFlash memory card attached to its internal CompactFlash interface. The recording commands (ATA-standard) are encoded by the camera interface card 12, and the encoded commands are received by the transport interface 25 of the processing unit 14 and are decoded (or translated) into ATA commands by the PLD 26, and by driver software operating on the microprocessor. The translated ATA commands are issued by the driver software to the internal ATA storage medium 28 of the processing unit, which operates in accordance with such commands.

The software operates in the processing unit 14 under supervision of the real-time operating system in use on the microprocessor examines the contents of the ATA storage device 28 as image files are written to the device 28 by the camera-to-processing unit hardware/software described above. As new image files are recorded (and any data association occurs if enabled in the image file name and header), the original (or modified if data association is enabled) files are copied (or transferred) to a remote image server or other destination device using one of several configurable network transport protocols (SSH, FTP, UNC, NFS, etc.), as defined in the data of the configuration file stored in the processing unit 14. Optionally, the locally-stored image files are deleted after their receipt by the remote network device has been verified, if the software is so configured. If camera response to the deletion of the locally-stored image files is undesirable, a small “dummy image” may be inserted by software on the processing unit in memory of ATA storage device 28. No modification of the digital camera is required for use with apparatus 10.

Referring to FIGS. 2A and 2B, the programming of the processing unit 14 of apparatus 10 with data association is shown. First, the user updates the configuration data via user interface 34 or web pages (such as in HTML) on the user's computer connected to the web server operating on the processing unit 14 (step 46). A home web page may be provided with links to: different web pages for updating configuration data; an image viewer page for reviewing stored images on the processing unit and selecting images for manual network transfer; or a status page for viewing status of the apparatus (e.g., ATA device capacity, status of network connections, or other operational status parameters). For example, web pages for updating configuration data may include: a network configuration page for establishing network connectivity; an image transfer configuration page; and a data association page. Other pages for updating other user configurable settings may also be provided. As stated earlier, menu and submenus to the data fields of these pages may also be updateable via user interface 34.

The network configuration page may, for example, have the following data fields for either or both wireless NIC 30 or wired LAN NIC 32: IP address mode (dynamic DHCP or static); if static, the IP address of a processing unit 14, and its subnet mask or gateway IP address if needed; DNS address mode (dynamic DHCP or static); if static, the primary DNS address of a processing unit 14, and secondary DNS address if the primary DNS address does work to establish network connectivity. Additionally, wireless network configuration may include other settings, such as enabling Wireless Encryption and Wireless Authentication, Authentication key, or digital certificates.

The image transfer configuration page may, for example, have the following data fields: transfer mode (automatic or manual); number of retry settings for establishing a connection to a host computer and interval between each retry; the primary host name or IP address, directory path, username, and password; and the secondary host name or IP address, directory path, username, and password, and the image transfer protocol (e.g., FTP or UNC or others earlier described). If after unsuccessful number of retries to the primary host, the processing unit 14 attempts to establish a connection to the secondary host. Optionally, a deletion protocol data field may be present to enable or disable the deletion of image files from the processing unit 14 after transfer over a network, with or without use of dummy image files as described earlier. The term host computer refers to the destination computer system or server on the network specified by the network configuration data.

The data association configuration page may be provided having the following fields: enable/disable data association; static data field(s), such as photographers name, location of shoot, subject, sequential identifier numbering, or other information desired by the user to be associated with each image captured; enable/disable auxiliary (dynamic) data association; and if auxiliary data association is enabled, pre-shot or post-shot mode. Sequential identifier numbering is the start number, and/or range of numbers, by which each image captured will be indexed.

Additional configuration page may be provided to enable the user to create different first partitions in ATA storage device 28 for virtual memory cards described earlier. At the bottom of each configuration page is a save changes button and a reset button, which a user may click using the mouse or other point device at the user's computer system. The reset button resets data fields to their previous settings, while selecting the save button the changed configuration data are stored in memory 24 of the processing unit 14 (step 47). If additional updates of the configuration are needed, the yes branch from step 48 is taken, otherwise the no branch is taken to step 50 and the processing unit waits for an image from the digital camera to be stored in the ATA storage device 28. Steps 46-48 may occur with the processing unit 14 connected or not connected to the digital camera via card 12.

Image capture step 50 requires the card 12 to be inserted into the memory slot of the camera and ready for data communication with the processing unit 14. When the user takes an image with the digital camera, the image file is written in the first partition of ATA storage device 28 or one of the first partitions if the user has enabled virtual memory cards (step 52). The processing unit 14 detects the new image (step 53) as described earlier, and then checks if Data Association (DA) is enabled (step 54). If data association is enabled in the stored configuration data, data association takes place (step 56) as detailed in the flow chart of FIG. 2B. If data association is not enabled, an image transfer component (program) establishes a connection with the network per the network configuration data, and transfers the image to the host over that network per the network transfer configuration data settings. If set for automatic transfer, each of the images are automatically transferred over the network to the host computer or server, and depending on transfer bandwidth may be queued for such transfer. If set for manual transfer, the user can access via the user's computer system coupled to the web server of the processing unit 14, a web page from the home web page which allows the user to view images stored on the processing unit 14, and select which of such images to be transferred per the network transfer configuration data. Optionally, the user interface 34 may enable a menu for selecting images to be manually transferred. A transfer may occur at such time the user desires. Preferably, the connection with the network is established prior to image capture for automatic transfer. If connection to the network is unsuccessful to either the primary or secondary hosts during automatic transfer, the image may be queued for manual transfer at a later time by the user. Once successful transfer has occurred of the image file, the image file in the first image partition may be deleted depending on the setting of the deletion protocols (step 60).

Data association of step 56 is described in FIG. 2B. First, when data association is enabled for each new image detected (step 62), the processing unit 14 checks if the ATA storage device 28 is a hard drive (step 64) or a second compact Flash card (step 65) located in the slot 28b of the processing unit. The second compact flash card may be used to provide an alternative ATA storage device for image files when a hard drive is not present or when hard drive is full. If neither a hard drive or second compact Flash card is present, the image is sent to the image transfer component (step 82) and the image is transferred as described earlier at step 58. If either a hard drive or second compact Flash card is present, the image file captured in the first partition of ATA storage device 28 is mirrored (copied) into the second partition of the ATA storage device (step 66), and a check is made as to whether auxiliary mode is enabled in the configuration data (step 68). If not so enabled, the static data of the configuration data is then associated with the mirrored image file by modify its filename to include the static data, and such static data is also entered into the EXIF header of the mirrored file (step 70).

For example, image files stored in the first partition may have the following filenames:

Image1.jpeg
Image2.jpeg
Image3.jpeg
Image4.jpeg
.
.
.
Image32.jpeg
Image33.jpeg

Image files in the second partition have modified file names incorporating one or more static data set in the configuration data, such as a text, separated by commas or underscores, to associate static data with images. An example of such a filenames for the above example is shown below by “photoname, photographer, barcode (or magnetic strip) data, sequential id”.

DSC0458, Joe Smith, 078742_66083,image000001.jpeg
DSC0459, Joe Smith, 078742_66083,image000002.jpeg
DSC0460, Joe Smith, 078742_66083,image000003.jpeg
DSC0461, Joe Smith, 078742_66084,image000004.jpeg
.
.
.
DSC0489, Joe Smith, 078757_66085,image000032.jpeg
DSC0490, Joe Smith, 078757_66085,image000033.jpeg

Other static data may similar be associated in the image filename.

If auxiliary mode is enabled at step 68, a check is made as to whether pre-shot mode is set in the configuration data (step 71). If not, then post-shot mode has been set and the mirrored image filename is stored in a queue in memory 24 of the processing unit (step 72). If in pre-shot mode, then auxiliary data is inputted by the user via reader 34a or other scanner prior to taking the next image(s) with the digital camera (step 74). For example, depending on the type of reader 34a data from up to 45 cards with magnetic strips, scanned barcodes, read RFID's, or other type of readable data medium, may be inputted. Optionally, auxiliary data may also be inputted via the user interface 34. Examples of auxiliary data include: place of shoot, name of subject, student or employee number, background, or other descriptive information identifying the subject matter of the images. The auxiliary data is stored in a buffer in memory 24 of the processing unit 14 until the user indicates on the user interface 34 (such as a button) that auxiliary data input is complete. The auxiliary data is then associated with the mirrored image by adding such data to the header of the image file (step 76) and then static data is associated with the image file at step 70 as described earlier. Fields of the EXIF header are specified by JPEG or other image file formats.

If in post-shot mode, then after image(s) are taken, data is inputted by the user at step 77 via reader 34a or other scanner similar to that performed at step 74. Optionally at auxiliary data input step 74 or 77, an unsuccessful and/or successful read of auxiliary data by reader 34a is communicated to the user by way of an audio notification (e.g., beep) and/or visual notification on the user interface or an LED on the processing units housing. For each image file whose filename is stored in the queue, that image is dequeued (step 78), auxiliary data is associated with the image at step 76, and then static data is associated with that image at step 70 is described earlier.

After step 70, a record is added in a history database of memory 24 with all of the static data and auxiliary data, if auxiliary mode is enabled, including both the image filename in the first and second partitions, and the location of the image on the ATA storage device 28 (step 80). The history database is optional, and provides means for recovering data association, if needed. After the history database is updated, the image file from the second partition is sent to the image transfer component (step 80) for transfer at step 58 of FIG. 2A. Next, a check is made whether post shot mode is enabled (step 83). If in post shot mode (step 83) and the queue is not empty (step 84), the next image in the queue is dequeued (step 78) and auxiliary data entered earlier at step 77 is associated with the image (step 76), the static data is associated (step 70), and the history database is updated (step 80) prior to sending the image to the image transfer component (step 82) for transfer at step 58 of FIG. 2A. If the queue is empty at step 84, or at step 83 post-shot mode is not enabled, the data association process waits for the next new image at step 62.

The history database may represent a relational database in memory 24 such as Microsoft SQL or Oracle, with different records and fields associated with images which may be transmitted to the user's computer system.

The processing shown in FIGS. 2A and 2B utilizes parallel processing or multithreading in which new image capture, storage and detection can occur while data association, if enabled, takes place, and other images are being transferred over an established network.

For example, the processing unit programming may have four main software components (or separate programs) running. A controller component which operates as a gateway for other software components accesses to configuration data stored in the registry, a network manager which operates in accordance with the network configuration data to set up the network connection, an image transfer component as described earlier for transferring images received, and a front panel controller for the user interface 34 to interface with the microprocessor. The controller updates all the other software components with any changes in configuration data needed for their operation. Other programming may be provided enabling similar functions to that detailed herein.

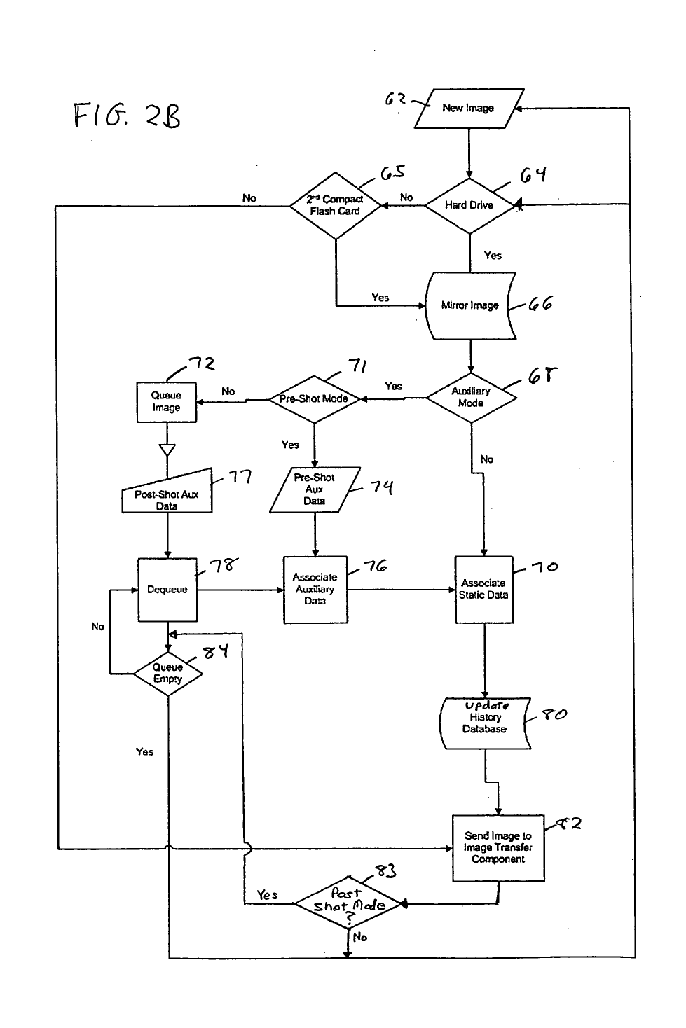

The processing unit 14 of apparatus 10 may in a housing in one of the forms or embodiments shown in FIGS. 3-5. In a first embodiment, the processing unit 14 is in a housing 14a shaped and sized to be worn in a belt-pack or body pack (FIG. 3). This configuration provides that the processing unit is worn at the photographer's hip or attached to the leg of a tri- or mono-pod camera support. In a second embodiment, the processing unit 14 is in a housing 14b sized for a backpack having straps 40 (FIG. 4). This configuration allows the range of the wireless network interface of the apparatus to be extended through the use of a bi-directional amplifier and a supplemental battery. The backpack form factor is required in order to provide support for an antenna mounted (via a fixed mast) above the head of the photographer. Due to the increased levels of RF output power produced by the bi-directional amplifier, such provisions are required for the photographer's safety. In a third embodiment, the processing unit 14 is in a housing 14c shaped like a motor drive unit and attached to the bottom of the camera, such as by a screw 42. Such a screw is inserted into the threaded hole in the base of the camera, typically used by such camera for mounting a tripod. In this compact implementation, housing 14c is mounted under the digital camera's body in a standard “motor drive” configuration. This configuration contains the same hardware as the body pack configuration, but does so in a miniaturized fashion in order to increase the portability of the device and decrease the number of hanging cables to be managed by the photographer. This configuration may be particularly useful to photographers who carry more than one camera body simultaneously, drastically reducing the complexity of their equipment setup. Although cable 16 is shown in FIGS. 3-6, cable may be eliminated by use of a wireless communication connection as described earlier.

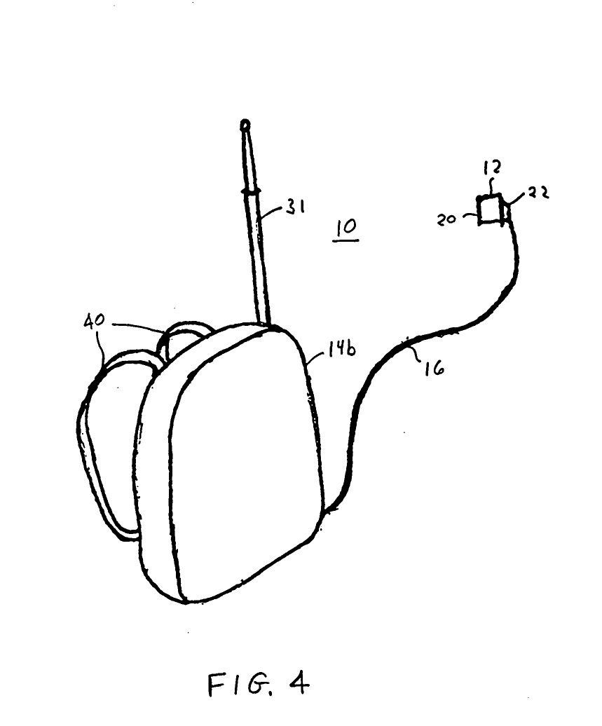

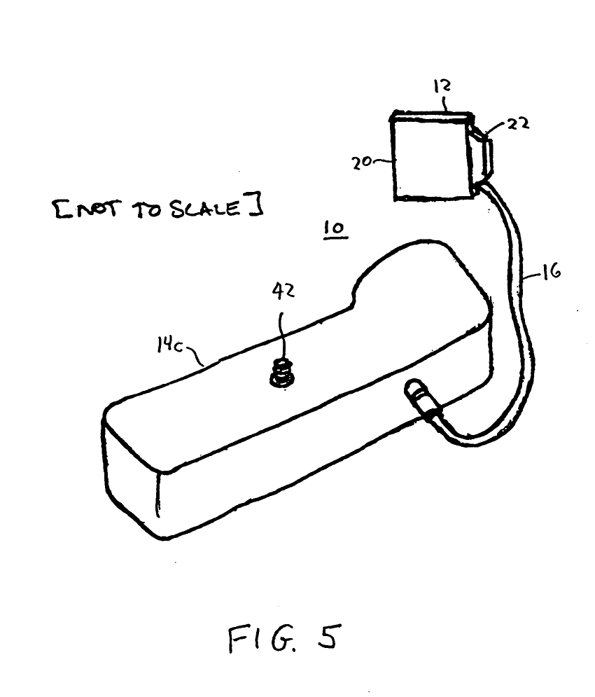

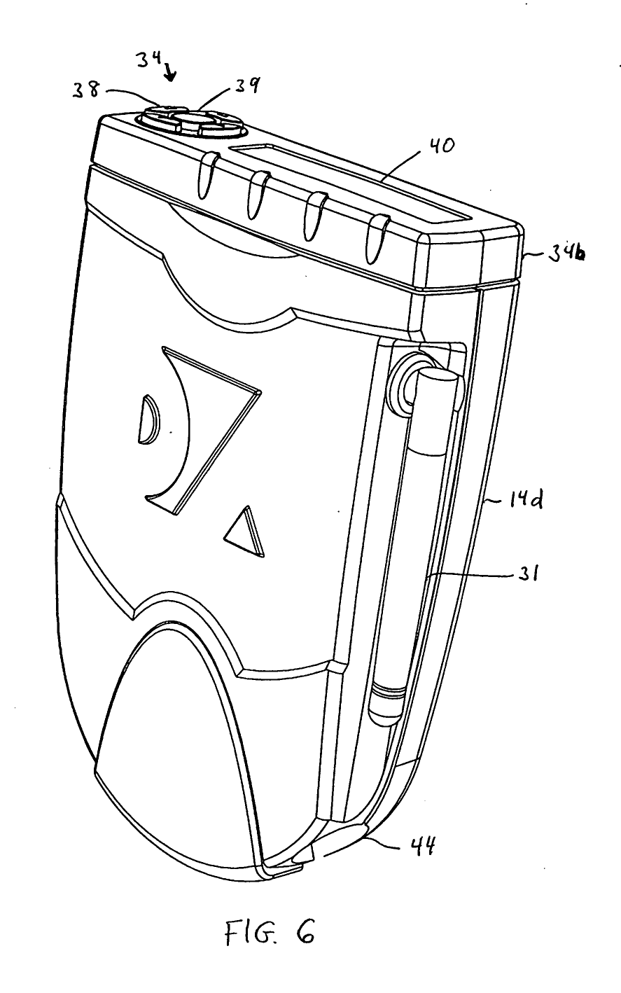

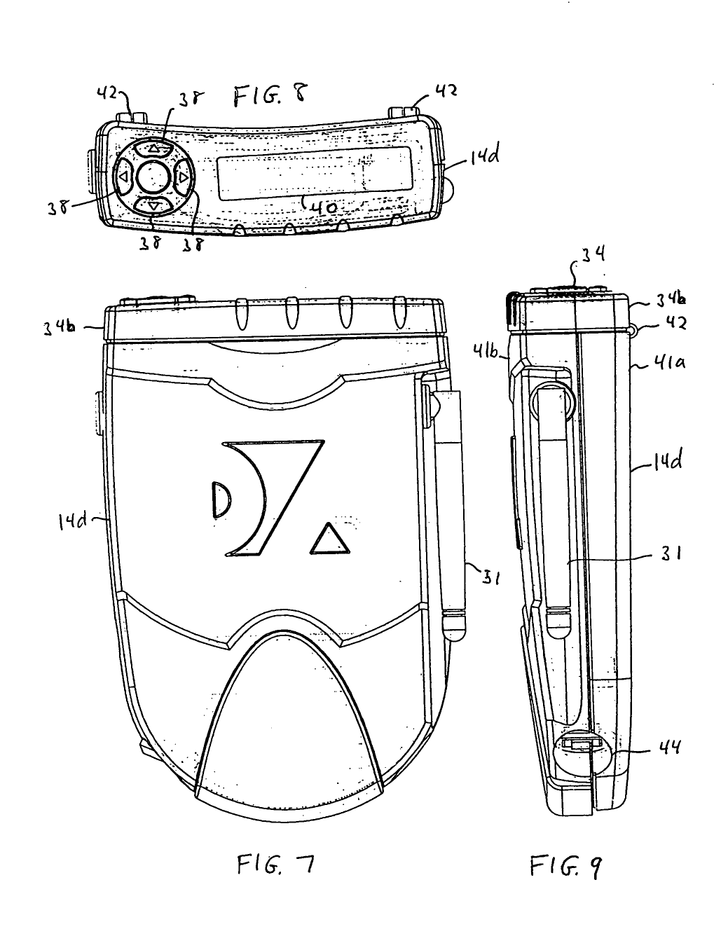

FIGS. 6-9 show an example of a housing 14d of miniature shape and size similar to a portable DVD or CD player, which may be worn by a user, such as in a belt-pack. The user interface 34 is shown having four directional buttons 38, and select or enter button 39, and an LCD screen 40. A menu based user interface may be used through which a user may toggle and select operations or enter information using buttons 38 and 39. LEDs on the housing may be provided to indicate on/off (or standby) or status of the apparatus 10. For example, a red/green LED may be provided to indicate the status of connection through the wireless NIC 30 or wired LAN NIC 32, and status of image transfer. The housing 14d may have a user accessible power connector for connection of power from an external battery or AC adapter to processing unit 14. Optionally, a battery may be provided in the housing to supply power to the unit. The housing may be made of two halves 41a and 41b of metal or molded plastic which mate together to contain the electronics therein. The user interface 34 may be in a module 34b pivotal on hinge 42, such that when in an open position (not shown) the user is provided access to CompactFlash sockets 28b in the housing. The interface may also be pivotable such that the user can orient the interface at different angles for each of user or viewing by the user. A port 44 is provided to connect cable 16, and an antenna 31 may be movable to different position. The user interface 34 may also be removable from housing and connected thereto by a cord or cable. Thus, the user interface may be strapped to the arm, or other body part of the user (or otherwise operate as a remote control) while the housing remains on the belt-pack.

In summary, the apparatus 10 connects to the host digital camera via the camera's CompactFlash interface located in its CompactFlash memory card slot or port. By emulating or mimicking the operation of an ATA-standard storage device (the standard to which CompactFlash memory cards conform) the apparatus collects image files as they are captured and written by the digital camera. The apparatus then can transmit these images with or without data association via available data network connections as specified by its configuration data stored in memory the processing unit. Although the digital camera used with apparatus 10 is described as a non-networked digital camera, the apparatus 10 may also be used with networked digital camera to provide additional network connectivity absent in the camera which enables the user to utilize data association prior to network image transfer.

From the foregoing description, it will be apparent that an apparatus for communicating over a network images captured by a digital camera has been provided without requiring any modification of the digital camera. Variations and modifications in the herein described apparatus and method in accordance with the invention will undoubtedly suggest themselves to those skilled in the art. Accordingly, the foregoing description should be taken as illustrative and not in a limiting sense.

1. An apparatus for communicating over a network images captured by a digital camera using a memory card slot of said camera, said apparatus comprising:
a processing unit having memory for storage of images and means for communicating said images over at least one network;
a camera interface card receivable in the memory card slot of said camera; and
means for coupling said camera interface card to said processing unit for data communication;
said camera interface card and processing unit provide means for emulating operation of a memory card for transfer of images captured by said camera via said coupling means for storage in said memory of said processing unit, in which said camera has access to said stored images in said memory of said processing unit; and
means capable of associating user data inputted to said processing unit with said images prior to communicating said images over said network.

2. The apparatus according to claim 1 wherein said processing unit detects each image stored in said memory and is capable of transferring at least one of said detected images in real-time over a network via a network connection established by said communicating means to another computer system.

3. The apparatus according to claim 1 further comprising a reader for inputting said user data into said processing unit.

4. The apparatus according to claim 1 wherein said reader is one of a barcode reader, magnetic card strip reader, or RFID reader.

5. The apparatus according to claim 1 wherein said coupling means is provided by a cable between said camera interface card and said processing unit.

6. The apparatus according to claim 1 wherein said coupling means enables wireless communication between said camera interface card and said processing unit.

7. The apparatus according to claim 1 wherein said processing unit is contained in a housing having a shape of a motor drive unit of a non-digital camera and is attachable to said digital camera similar to a motor drive unit.

8. The apparatus according to claim 1 wherein said processing unit is contained in a housing shaped to be worn on a belt by a user of said digital camera.

9. The apparatus according to claim 1 wherein said processing unit is contained in a housing shaped to be worn as a backpack.

10. The apparatus according to claim 1 wherein said processing unit represents a computer system with said memory provided by a ATA storage device.

11. The apparatus according to claim 10 wherein said ATA storage device is one of a hard disk drive or a Compact Flash card.

12. The apparatus according to claim 10 wherein said camera interface card comprises a circuit for converting ATA protocol commands received from said camera into encoded commands, and transferring said encoded commands via said coupling means to said computer system.

13. The apparatus according to claim 12 wherein said computer system receives said encoded commands and decodes said encoded commands into ATA protocol commands, and said computer system operates responsive to said decoded commands to emulate a memory card of said digital camera for writing images captured by said digital camera or reading by said digital camera of said stored images.

14. The apparatus according to claim 1 wherein said processing unit is provided in a housing separate from said camera.

15. The apparatus according to claim 1 wherein said processing unit further comprises one of a user interface on said processing unit or a web-based interface for enabling a computer system to update configuration data in said processing unit for enabling at least configuring said network, at least one network destination address, and protocol for transfer of images over said network.

16. The apparatus according to claim 1 wherein said means for communicating enables wireless transfer of said images to another computer system on said network.

17. The apparatus according to claim 1 wherein said means for communicating enables wired transfer of said images to another computer system on said network.

18. The apparatus according to claim 1 wherein said processing unit detects each image stored in said memory and queues each image for transfer over a network connection when established by said communicating means.

19. The apparatus according to claim 1 wherein said camera is without a network interface on-board said camera;

20. The apparatus according to claim 1 wherein said memory of said processing unit has at least a first partition for storing images in files received from said camera via said camera interface card, and a second partition for storage of the same images in files as said first partition in which said files in said second partition are modified to include said user inputted data for association with the images.

21. The apparatus according to claim 20 wherein said user inputted data for association with the images modifies the header of said files in said second partition.

22. The apparatus according to claim 20 wherein said user inputted data for association with the images modifies the filename of said files in said second partition.

23. The apparatus according to claim 1 where said user inputted data is selectably inputted before or after one or more of said images are captured.

24. The apparatus according to claim 23 wherein said processing unit is capable of being coupled to a reader for receiving said user inputted data.

25. The apparatus according to claim 1 wherein said memory of said processing unit has two or more partitions for enabling virtual memory cards.

26. A method for communicating over a network images captured by a digital camera using a memory card slot of said camera, said method comprising the steps of:
providing a computer system having memory for storage of images;
inserting a camera interface card in the memory card slot of said camera;
coupling said camera interface card to said computer system for data communication;
emulating operation of said a memory card for transfer of images captured by said camera for storage in said memory of said computer system, in which said camera has access to said stored images in said memory of said computer system; and
associating user data inputted to said computer system with said images prior to communicating said images over said network.

27. A system for communicating over a network images captured by a digital camera using a memory card slot of said camera comprising:
a computer system having memory for storage of images;
a camera interface card insertable in the memory card slot of said camera in which said camera interface card and said computer system are coupled for data communication;
means for emulating operation of said a memory card for transfer of images captured by said camera for storage in said memory of said computer system, in which said camera has access to said stored images in said memory of said computer system; and
means capable of associating user data inputted to said computer system with said images prior to communicating said images over said network.
